(19) United States
(12) Patent Application Publication
(10) Pub. No.: US 2011/0302788 A1
(43) Pub. Date: Dec. 15, 2011

(54) SAFETY SCISSORS FOR HAIRDRESSERS/BARBERS/GROOMERS

(76) Inventor: Donald Jason Milligan, Fulton, KY (US)

(21) Appl. No.: 13/153,437

(22) Filed: Aug. 22, 2011

Related U.S. Application Data
(60) Provisional application No. 61/352,239, filed on Jun. 7, 2010.

(51) Int. Cl. B26B 13/06

(52) U.S. Cl. 30/233

(57) ABSTRACT

As illustrated in (FIG. 1) a pair of “Point-Cutting” safety scissors that incorporate a precision/safety tip feature allowing for greater precision and stylist safety for use in “Point-Cutting” techniques of cutting hair. These “Point-Cutting” safety scissors are characterized by a void located at the tips of the left and right blades in the shape of a “quarter-elliptical arc” (101). This particular novel shape provides greater cutting precision and optimum stylist safety while performing “Point-Cutting” techniques. Thereby, allowing the stylist to cut closer by resting the tips of the said blades on their fingers without the risk of being cut.

### CROSS REFERENCE TO RELATED APPLICATIONS

This application claims the benefit of U.S. Provisional Patent Application No. 61/352,239, filed. Jun. 7, 2010.

### FIELD OF THE INVENTION

The present invention relates to safety scissors. More specifically, safety scissors for “Point-Cutting” hair that utilize a precision/safety tip feature allowing for greater precision and safety.

### BACKGROUND OF THE INVENTION

The invention will be described with the reference to a hair cutting scissor (as shown in FIG. 1), but persons skilled in the art will recognize that the present embodiments of the said precision/safety tip feature are novel and applicable to many other scissor types and use applications.

For hairdressers, one of the most widely used methods of texturing and cutting hair is called “Point-Cutting”.

The problem with using conventional shears for “Point-Cutting” are the razor sharp edge tips (as shown in FIG. 3-301) These tips frequently come into contact with the users fingers and knuckles breaking the skin, posing unsanitary health concerns for the stylist and general public.

The “Point-Cutting” technique can be briefly defined in the following steps. 1. Holding a small section of hair between fingers. 2. Approach the hair and fingers holding scissors at a 45 to 80 degree vertical angle. 3. Repeatedly open and close the scissors on the hair moving up the section, cutting small segments out of the ends of the hair.

The “Point-Cutting” technique is vital in removing weight from the ends of the hair to create a more natural flowing haircut. Using the “Point-Cutting” technique can take years to master. Even after years of experience a stylist using conventional scissors (as shown in FIG. 3) will continue to cut their fingers while performing “Point-Cutting” techniques.

The pain from cutting ones finger can range from uncomfortable to painful. Repeated finger cuts can inhibit the stylist from using the “Point-Cutting” technique, which intern is detrimental to a stylist future success.

The sanitation and health concerns of the general public that arise from a stylist open cut are obvious and no one wants the blood of a stylist on there head.

This problem of cutting fingers while “Point-Cutting” can be alleviated with the embodiments of said “Point-Cutting” safety scissors included in this application.

Although scissors with safety features are known, there are no known safety scissors for cutting hair specifically designed for “Point-Cutting” that include a precision/safety tip feature.

### SUMMARY OF INVENTION

The embodiments of this application provide a “Point-Cutting” safety scissor with a precision/safety tip feature. The embodiments described herein include a precision/safety tip feature in which a “quarter-elliptical arc” section of the interior cutting edge blade tips are removed.

The present embodiments of the said precision/safety tip feature creates a unique blade tip that allows the hairdresser greater precision and safety while performing “Point-Cutting” techniques.

The present embodiments of the said precision/safety tip feature can be placed on varied scissor lengths, styles and handle designs.

### BRIEF DESCRIPTION OF THE FIGURES

FIG. 1—plain view of “Point-Cutting” safety scissors with the precision/safety tip feature-in the open position.

FIG. 1A—magnified view of “Point-Cutting” safety scissors with the precision/safety tip feature-in the open position.

FIG. 2—plain view of “Point-Cutting” safety scissors with the precision/safety tip feature-in the closed position.

FIG. 2A—is a magnified view of “Point-Cutting” safety scissors with the precision/safety tip feature-in the closed position.

FIG. 3 (prior art)—plain view of a conventional pair of hair scissors for hairdressers in the open position.

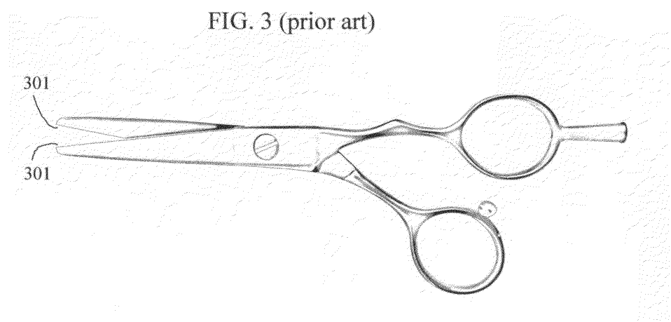

### DETAILED DESCRIPTION

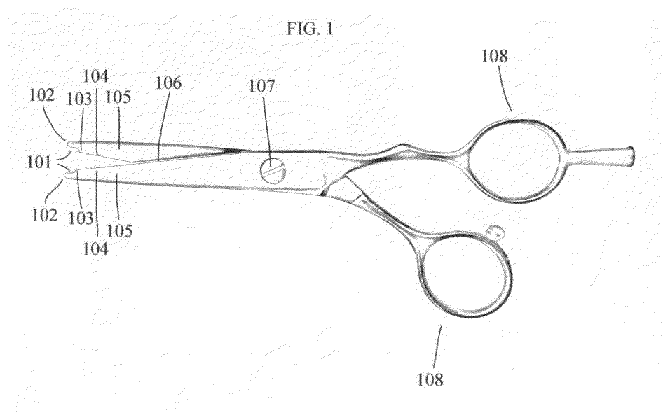

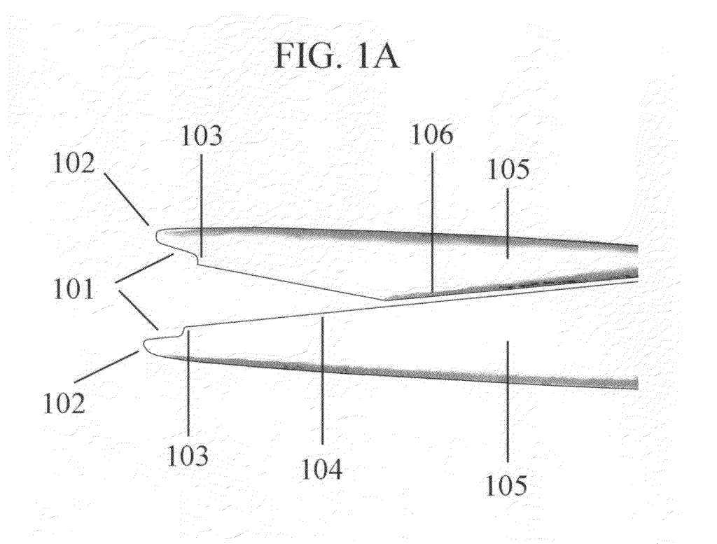

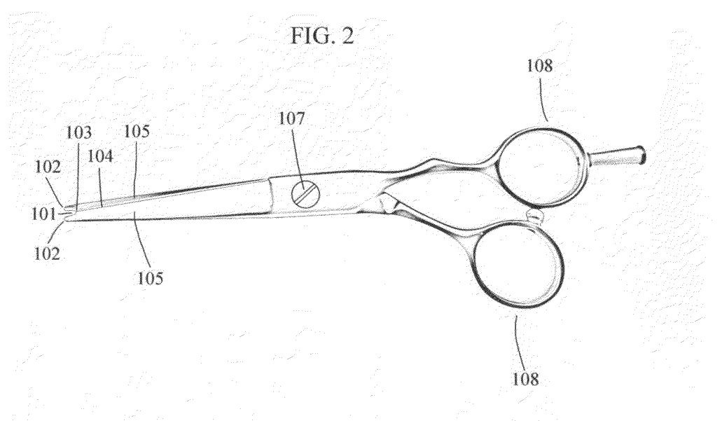

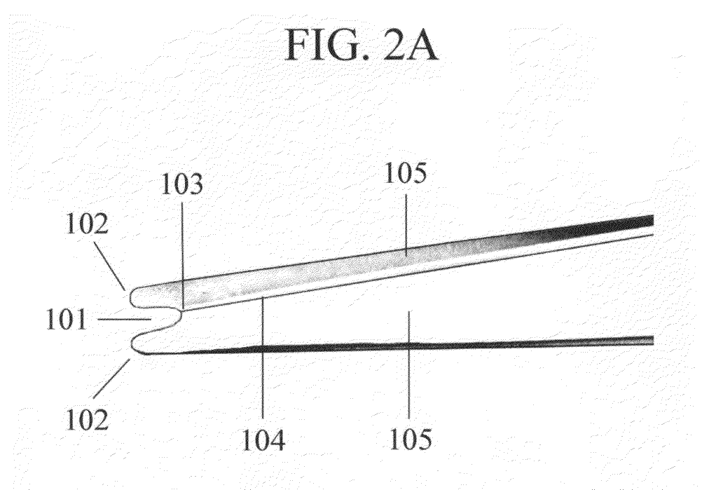

Embodiments of the present invention are illustrated in the following references to drawings FIG. 1, FIG. 1A, FIG. 2 and FIG. 2A.

A left blade 105 and a right blade 105 that cross over one another in a shearing or cutting action 106, connected at a pivoting point 107 with handles 108.

A said left blade 105 having a “quarter-elliptical arc” section of the interior cutting edge removed at the blade tip 101.

A said right blade 105 having a “quarter-elliptical arc” section of the interior cutting edge removed at the blade tip 101.

The furthermost tips on said left and right blades end in a small smooth rounded point 102.

The removed segment of the cutting edge tips are in the shape of a “quarter-elliptical arc” 101. This particular novel shape provides greater cutting precision and optimum stylist safety while performing “Point-Cutting” techniques. Thereby, allowing the stylist to cut closer by resting the tips of the said blades on their fingers without the risk of being cut.

(as shown in FIG. 1 101) The present embodiments of this application provide a precision/safety tip feature with a non-cutting area at the tip of the said blades that increases “Point-Cutting” precision and prevents catching or pinching of the hair or finger. (as shown in 103) the beginning of cutting edge of the said blades. As shown in 104 the continuation of the cutting edge said scissor blade.

Alternative embodiments of the invention not shown in the figures include various scissor lengths, styles and handle designs comprised of many different materials such as plastic, aluminum, stainless steel, and various other metal alloys.

Scissor length, style and handle design can vary greatly and still utilize the said embodiments of the present application 101.

The said embodiments of the present application have been described in connection with hair scissors suitable for use by hairdressers, barbers and groomers. However, it is to be understood that the said embodiments of this present application are applicable for use with other types of scissors as well.

A preferred method of manufacturing the said embodiments of the “Point-Cutting” precision/safety tip feature; include cutting out the “quarter-elliptical arc” by methods of grinding said left and right blade during the scissor manufacturing process before the blades are tempered and sharpened.

### CONCLUSIONS

Through out the invention process the inventor experimented with several different shaped safety tips. Some of the cut-out shapes included “L” shapes, “V” shapes and the “quarter-elliptical arc” shape. 101 as defined in the current embodiment included in this application.

Numerous tests involving optimum hair cutting performance and stylist safety were incorporated during this testing phase. The “L” shapes and “V” shapes tested poorly in both areas of performance and safety proving a lack in commercial viability.

It was determined by the inventor and test stylists during commercial applications of the extensive testing phase that the “quarter-elliptical arc” shaped, safety tip design 101 was preferred for optimum hair cutting performance and stylist safety.

1. Safety scissors for hairdressers/barbers/groomers featuring a safety tip, located at the tip of the cutting blades.

2. Safety scissors for hairdressers/barbers/groomers of claim, a protuberance projecting from the tips of the blades of said scissors providing protection from injury of unwanted fingers cuts incurred by contact with the tips of the cutting edge of the blades of the said scissors.

3. Safety scissors for hairdressers/barbers/groomers of claim, a method of protecting a users fingers from cuts while cutting hair by providing a safety tip at the end of said scissor blades.

4. Safety scissors for hairdressers/barbers/groomers of claim, an extension of a non-cutting edge on two blades of a scissor that provide a no-cut area for protection against unwanted finger cuts.

5. Safety scissors for hairdressers/barbers/groomers of claim, a method of protecting a users fingers from cuts by said scissors blade tips not closing completely.

6. Safety scissors for hairdressers/barbers/groomers of claim, a method of protecting a users fingers from unwanted cuts by said scissors by creating a void at the blade tips that prevents the scissors from completely closing at the tips.

7. Safety scissors for hairdressers/barbers/groomers of claim, a performance stylist safety shear that utilizes a continuous blade design to provide comfort, balance, safety and utility.
